(19) United States
(12) Patent Application Publication
(10) Pub. No.: US 2003/0127859 A1
(43) Pub. Date: Jul. 10, 2003

(54) Reinforcing arrangement at pipe penetration

(75) Inventors: Mats Isaksson, Sodertalje (SE); Per-Ola Post, Sodertalje (SE)

Correspondence Address: OSTROLENK FABER GERB & SOFFEN, 1180 AVENUE OF THE AMERICAS, NEW YORK, NY, 100368403

(73) Assignee: SCANIA CV AB

(21) Appl. No.: 10/039,122

(22) Filed: Jan. 7, 2002

(51) Int. Cl. F16L 17/00

(52) U.S. Cl. 285/374

(57) ABSTRACT

A reinforcing arrangement for a pipe penetration in an element such as a wall or a loadbearing element, particularly in an environment subject to vibration, the wall having a penetration aperture therethrough. The pipe penetration includes a tubular device which extends at least partly through the penetration aperture and is provided with an external circular bead received in the penetration aperture and by which the tubular device is axially affixable in the penetration aperture. A retaining device fixes the bead in the penetration aperture and fixes the tubular device. A reinforcing sleeve or pipe installed in the tubular device in the region of the circular bead to provide internal reinforcement and stiffening of the tubular device. The reinforcing sleeve prevents vibration generated fatigue fracture of the tubular device in the region of the circular bead.

### BACKGROUND OF THE INVENTION

The present invention relates to a pipe reinforcing arrangement for a pipe that penetrates an element in an environment subject to vibration. This kind of reinforcing arrangement is relevant to a pipe penetration which incorporates a wall element or loadbearing element which is provided with a through aperture or penetration aperture with which a tubular device cooperates. The tubular device may, for example, form part of a fluid line which is supported by and extends through the wall element/loadbearing element. It may for example be applicable to a brake pipe penetration in a motor vehicle.

Innumerable technical contexts involve the need to convey fluids (i.e. gases and liquids) between various units and components. In hydraulics, this may for example involve conveying pressurized liquid from a hydraulic pump to or a piston-and-cylinder arrangement or a servomotor for effecting a maneuvering or repositioning movement or for performing mechanical work. In pneumatics, the purpose may correspondingly be to convey compressed gas (e.g. compressed air) from a compressor to an actuator, servomotor or compressed-gas-driven arrangement for changing the position of a machine element or quite generally for performing work.

The distance between the respective pressure source (which may be a pump, a compressor or a pressure medium reservoir) and the unit driven by the pressure medium makes it necessary to install a shorter or longer pipeline. This pressure medium line, e.g. a compressed air line, has to then be held in position by pipe mountings and other position fixing devices. Particularly in a motor vehicle, it may be necessary, including for space reasons, for such a pressure medium line to be installed in a space-saving manner. This may entail the line having to incorporate both curves and sharp bends and turns and pass through apertures (penetrations) in various kinds of intermediate walls, intermediate structural elements, stiffening elements and beams. It is often appropriate to combine such pipe penetrations with position fixing points for the pipeline.

Certain parts of a vehicle, particularly a motor vehicle, for structural and functional reasons have to be able to undergo a certain mutual movement, e.g. the vehicle's wheels and their associated braking arrangements must be able to move vertically relative to the chassis or vehicle frame, and the vehicle engine has to be suspended vibration dampingly relative to the chassis/vehicle frame. This means that a pressure medium line connected thereto has partly to be fixed in position and partly allow a certain degree of mobility, including catering for the pattern of movement to which the line concerned is subjected owing to movements or vibrations of movable or vibrating units from/to which the line runs via a position fixing pipe penetration in a wall element or supporting fastening element.

Such a position-fixing pipe penetration will in practice often be subject to a not insignificant amount of vibration effects in a motor vehicle or any other type of pipe environment where there is obvious risk of vibration effects.

### OBJECT OF THE INVENTION

The object of the invention is to provide a position-fixing pipe penetration in such a way that the risk of vibration generated fatigue fracture of the pipeline in the pipe penetration region can be prevented entirely or can at least be reduced to such an extent as to be of no significance in practice.

### DESCRIPTION OF THE INVENTION

The aforesaid object is achieved according to the invention with a reinforcing arrangement for a pipe penetration located in an element such as a wall with loadbearing element, particularly in an environment subject to vibration. The wall has a penetration aperture therethrough. The pipe penetration includes a tubular device received in the penetration aperture. The tubular device extends at least partly through the penetration aperture. The device is provided with an external circular bead that is received in the penetration aperture and by which the tubular device is axially fixable in the penetration aperture. A retaining device on the wall fastens the bead in the penetration aperture. A reinforcing sleeve or pipe installed in the tubular device in the region of the circular bead provides internal reinforcement and stiffening of the tubular device. The reinforcing sleeve prevents vibration generated fatigue fracture of the tubular device in the region of the circular bead.

A primary distinguishing feature of such a reinforcing arrangement is that the tubular device (e.g. a compressed air line) at least partly extends through the penetration aperture and is provided with an external circular bead by which the device is axially fixable in the penetration aperture. This positional fixing involves the use of at least one cooperating retaining device which is fastenable in the wall element or loadbearing element. A reinforcing sleeve, e.g. in the form of a length of pipe, is inserted inside the tubular device and stiffens the tubular device, and it is situated in the region within the circular bead. This reinforcing sleeve thus abuts against the inside of the tubular device and strengthens the device so that the risk of fatigue fracture of the device (due to vibrations of the device clamped firmly in the wall element/loadbearing element by means of the circular bead and the retaining device) is entirely eliminated in the region thus reinforced.

The tubular device's (i.e. the pressure medium line's) circular bead with its associated rounded fillets has an inherent tendency to act as a kind of pipeline wall fracture indication if the tubular device is subjected to frequently occurring vibrations. The pipeline wall reinforcement and stiffening achieved (in the region of the circular bead) by using a reinforcing sleeve inserted in the tubular device according to the invention effectively and at minimum cost prevents the risk of fatigue fracture due to vibrations that would otherwise occur in this sensitive fastening region.

In a preferred embodiment, wherein the tubular device has fully developed pipe portions on both sides of the circular bead, one pipe portion extends through a narrower (preferably circularly cylindrical) part of the penetration aperture, while the circular bead is accommodated in an annular broadened part of the penetration aperture. Optimum reinforcing effect is achieved if the inserted reinforcing sleeve extends along the inside region of both pipe portions.

Effective fastening of the tubular device (hereinafter called the pipe device) may for example be achieved by a retaining device in the form of a securing element which, for example, has an annular, U or horseshoe shape and surrounds the pipe device and has a radial edge portion radially directed inwards towards the pipe which, either along the whole circular bead or at certain points along it, protrudes inwards radially over and abuts against the circular bead. The retaining device may be fastened to the wall element/loadbearing element by various means, e.g. by means of special fastening devices.

On either or both sides of the circular bead there may be, abutting against it, sealing rings or securing rings made of material with suitable elastic (sealing and/or vibration damping) characteristics. A practical application of the invention specific to vehicle technology is distinguished by the pipe device constituting the upstream end part of a compressed air brake line which starts from a compressor which may for example be mounted on a vehicle engine which is vibration dampingly suspended. The penetration aperture then continues through a wall portion or wall element belonging to the compressor. Vibration movements which are consequently imparted to the pipe device (the compressed air pipeline) from the compressor might, in the absence of a reinforcing arrangement as above, lead to vibration fatigue fracture at the pipe penetration in the wall portion or wall element where the pipe device is also position fixingly fastened.

### BRIEF DESCRIPTION OF THE DRAWINGS

The invention is exemplified below by describing an embodiment of a pipe penetration reinforcement illustrated in the accompanying drawings, which are as follows:

FIG. 1 depicts a section through a pipe penetration in a wall portion of a compressor,

FIG. 2 depicts a diametral longitudinal section through the tubular device provided with an internal reinforcing sleeve in the pipe penetration according to FIG. 1, and

FIG. 3 depicts the pipe penetration according to FIG. 1 in perspective as seen from above.

### DESCRIPTION OF A PREFERRED EMBODIMENT

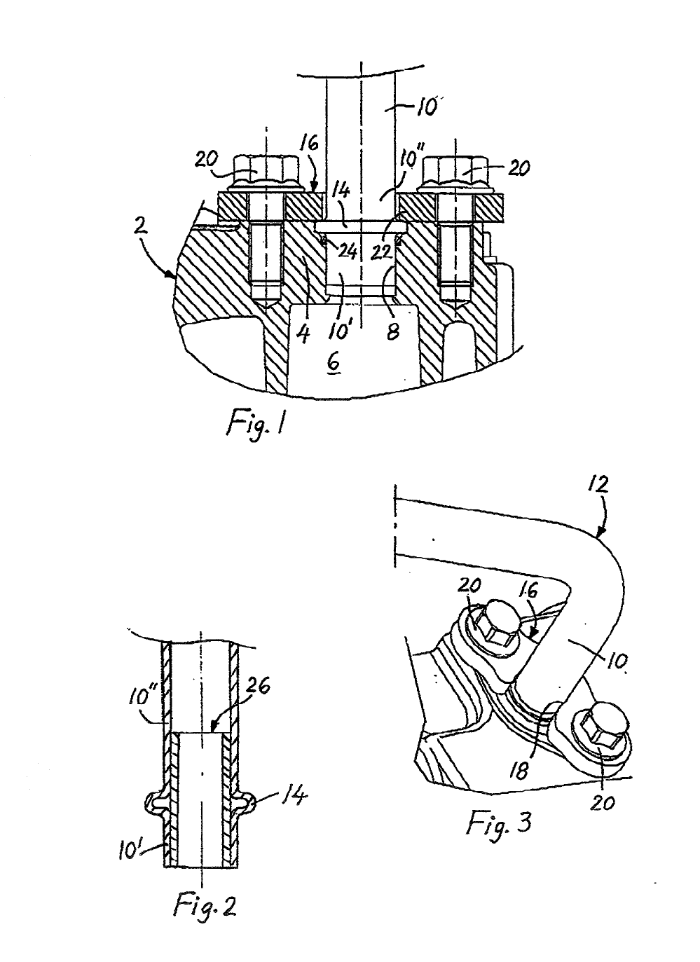

FIG. 1 depicts in section a region 2 of a compressor which is mounted, for example, on a vehicle engine (not depicted) and which has a wall portion 4 which forms an upper delineating wall for a chamber 6 in the compressor. In the upper wall portion 4 there is a penetration aperture 8 in which is fastened a pipe device in the form of an upstream end part 10 of a compressed air pipeline 12 which starts from the compressor and which may be supposed to lead, for example, to a compressed-air-operated wheel brake arrangement. The pipe device 10 incorporates in its wall (see particularly FIG. 2) an external circular bead 14 by which the pipe device is fixed in the penetration aperture 8 by means of a cooperating retaining device 16.

The circular bead 14 is accommodated in an outer wider part of the penetration aperture 8. Also inserted in this wider part of the aperture 8 is an elastic sealing ring 24 which is held in position on the inner portion 10′ of the pipe device 10 by the circular bead 14 which forms a demarcation between the inner pipe portion 10′ and an outer portion 10″ of the pipe device. Thus the retaining device 16 provided with a U-shaped recess 18 for the pipe device 10, has the shape of a stirrup-like securing element (see FIG. 3) which is screwed firmly to the outside of the wall portion 4 by means of a pair of screws 20. The edge portion 22 of the securing element 16 protrudes radially inwards over the circular bead 14, thereby holding it firmly in the fastening position.

A tubular reinforcing sleeve 26 (see FIG. 2) which may be in the form of a stiffening length of pipe is inserted inside the tubular device (the pipe device 10) in the region within the circular bead 14. The sleeve is of a size or diameter as to contact the interior of the tubular device. The sleeve provides reinforcement and stiffening inside the pipe device 10 and prevents the pipe device from being subject to the risk of fatigue fracture caused by vibration effects in the circular bead region which would otherwise act as a kind of “fracture indication”. The reinforcing sleeve 26 extends along the inside region of both the pipe portion 10′ and the pipe portion 10″.

Although the present invention has been described in relation to a particular embodiment thereof, many other variations and modifications and other uses will become apparent to those skilled in the art. It is preferred, therefore, that the present invention be limited not by the specific disclosure herein, but only by the appended claims.

What is claimed is:

1. A reinforcing arrangement for a pipe penetration into an element, wherein the element has a penetration aperture for receiving the pipe penetration, the pipe penetration comprising
a tubular device extending at least partly through the penetration aperture in the element;
an external bead around the tubular device for cooperating with the penetration aperture for axially fixing the tubular device in the penetration aperture;
at least one cooperating retaining device on the element for retaining the bead and the tubular device at the element;
a reinforcing sleeve or stiffening length of pipe inserted inside the tubular device for providing internal reinforcement or stiffening inside the tubular device.

2. The reinforcing arrangement of claim 1, wherein the penetration aperture includes a narrower part and a wider part;
the tubular device comprising a first pipe portion at one axial side of the circular bead and a coaxial second pipe portion on an opposite axial side of the circular bead, with the first pipe portion extending through the narrower part of the penetration aperture and the circular bead being accommodated in the wider part of the penetration aperture.

3. The reinforcing arrangement of claim 2, wherein the reinforcing sleeve or stiffening length of pipe inserted in the tubular device extends along and inside both the first and second pipe portions.

4. The reinforcing arrangement of claim 3, wherein the reinforcing sleeve or stiffening length of pipe contacts the interior of the tubular device.

5. The reinforcing arrangement of claim 2, wherein the retaining device includes a securing element which at least partly surrounds the tubular device;
the securing element having an edge portion directed radially inward toward the tubular device and at at least some points along the circular bead protrudes radially inwardly over the bead for retaining the bead.

6. The reinforcing arrangement of claim 5, wherein the retaining device is releasably fixed to the element.

7. The reinforcing element of claim 6, further comprising a separate fastening device for releasably fixing the retaining device to the element.

8. The reinforcing arrangement of claim 7, wherein the element with the penetration aperture has holes therein and the fastening device comprises a screw or a bolt running through each of the fastening holes.

9. The reinforcing arrangement of claim 5, wherein the edge portion of the securing element abuts the bead.

10. The reinforcing arrangement of claim 5, wherein the retaining device has a U-shaped recess for the tubular device and the tubular device is received in the U-shape.

11. The reinforcing arrangement of claim 1, further comprising an elastic ring in the penetration aperture on at least one axial side of the bead and abutting against the circular bead and against the wall defining the penetration aperture.

12. The reinforcing arrangement of claim 1, wherein the tubular device comprises an end portion of a compressed air brake pipe and the element with the penetration aperture comprises a wall portion of a compressor.
